(19) United States
(12) Patent Application Publication
(10) Pub. No.: US 2006/0125747 A1
(43) Pub. Date: Jun. 15, 2006

(54) Display device and automatic synchronization judging circuit

(75) Inventors: Hiroshi Takeda, Kanagawa (JP); Youji Hirano, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, Kawasaki-shi (JP)

(21) Appl. No.: 11/297,449

(22) Filed: Dec. 9, 2005

(30) Foreign Application Priority Data
Dec. 13, 2004 (JP) 2004-360601

(51) Int. Cl. G09G 3/36; G09G 5/00

(52) U.S. Cl. 345/87; 345/213

(57) ABSTRACT

An automatic synchronization judging circuit to be used in a liquid crystal display device is provided which is capable of realizing, by a small-scale circuit, a function of correctly judging a synchronizing signal to serve as a reference signal for displaying operations in any case of combinations of synchronizing signals to be input. The automatic synchronization judging circuit includes a counter and a judging device. The counter, when having counted a DE (Data Enable) signal up to a predetermined number being 1 or more, makes a signal output from the counter go high and stops the counting. The judging device generates a judging signal. If the judging signal is high, the driving mode is judged as a “fixed mode” which uses a vertical synchronizing signal and a horizontal synchronizing signal as the reference signal. If the judging signal is low, the driving mode is judged as a “DE mode” which uses the DE (Data Enable) signal as the reference signal.

### BACKGROUND OF THE INVENTION

1. Field of the Invention

The present invention relates to a display device of a liquid crystal display device or a like and an automatic synchronization judging device to be used in the display device and more particularly to the display device and the automatic synchronization judging device capable of realizing, by a small-scale circuit, a function of correctly judging a synchronizing signal to serve as a reference signal for displaying operations in the display device.

The present application claims priority of Japanese Patent Application No. 2004-360601 filed on Dec. 13, 2004, which is hereby incorporated by reference.

2. Description of the Related Art

A liquid crystal display device using a liquid crystal display panel is widely used as a displaying means for TV (Television) sets, personal computers, PDAs (Personal Digital Assistants), portable phone terminals, game machines, or a like. FIG. 9 is a block diagram showing an example of electrical configurations of a conventional liquid crystal display device. The liquid crystal display device includes a liquid crystal display panel 1 to display a video or information to be input as display data, a source driver 2 (a drain driver is also used depending on configurations of the liquid crystal display panel 1 in some cases), a gate driver 3 both operating to drive the liquid crystal display panel 1, and a display controlling section 4 to control each of the drivers 2 and 3. To the display controlling section 4 are input a vertical sync (VSC) signal, a horizontal sync (HSC) signal, a data enable (DE) signal, a dot clock (DCLK), a data signal, or a like from an external circuit (not shown) such as a personal computer. The display controlling section 4 captures a data signal using these external signals and generates a control signal to control each of the source driver 2 and the gate driver 3 and outputs the generated control signal, whereby display data are displayed on the liquid crystal display panel 1.

The display controlling section 4 outputs source data corresponding to each line to be driven. Ordinarily, as the source data to be output by the display controlling section 4, data signal captured, in a serial format, by the DCLK signal in synchronization with the DE signal is output in a serial format in the same way. In some case, sorting of input display data is required depending on a driving method of the liquid crystal display panel 1. In this case, the input display data are input to the display controlling section 4 after having been saved on a temporary basis and having been sorted. The input display data are sorted in the display controlling section 4 in some cases. In the present liquid crystal display panel, polarity control on a driving voltage is required and, therefore, a voltage polarity control signal (PC) is output to the source driver 2 in a manner to correspond to a line to be driven.

The display controlling section 4 outputs a vertical start pulse (VSP) at a head in a frame and a continuous vertical shift clock (VCK) to the gate driver 3. The display controlling section 4 exerts control so that the VSP is shifted by the VCK and the source data are output to each of lines (01, 02, 03, . . . ) to be driven. At this time point, the display controlling section 4 outputs a vertical output enable signal (VOE) so that masking is carried out to prevent outputting of the source data while each of the lines to be driven is being shifted and the source data are output when, after termination of the shifting, specified lines are driven.

As described above, capturing of data signals, creation of control signals to be output to each driver, or a like are performed by a timing control function of the display controlling section 4 which controls timing by using the VSC and the HSC signals input from the outside as a reference signal. However, technology is disclosed in which an idea is employed that the VSC and HSC signals are not any longer required if a DE signal is used, and a case appears in which display is controlled by using the DE signal as a reference signal without using the VSC and HSC signals. That is, since a vertical blanking period is much longer than a horizontal blanking period, when a low period of the DE signal is monitored and if the low period of the DE signal is longer than a specified period of time, it is judged that vertical synchronization occurs. Then, by employing a method in which data of the first line following rising-of the DE signal up to a high period is captured, inputting of the VSC and the HSC signals becomes unnecessary.

From a standpoint of making an interface of a liquid crystal display device have general versatility, it is preferable that the same display controlling section can control the displaying irrespective of whichever synchronizing signal is input. To solve this problem, technology is disclosed, for example, in Japanese Patent Application Laid-open No. Hei10-148812 (Patent Document 1) in which a display controlling section of a liquid crystal display device can automatically judge which input synchronizing signal, out of VSC, HSC, and DE signals, is to be used as a reference signal to make a liquid crystal display panel display data. The conventional device is so configured that, when the VSC and the HSC signals are input, even if the DE signal has been input, synchronization is detected by using the VSC and HSC signals. Also, according to the conventional technology, in order to judge whether or not the VSC, HSC, and DE signals have been input, DCLK signals in a period during which the VSC signal is high and low are counted up to a predetermined number and, if the period is larger than the predetermined count number, it is judged that the synchronizing signals are not input. Similarly, the period during which the HSC and DE signals are high and low is longer than a predetermined period of time, it is judged that HSC and DE signals are not input.

Moreover, as the conventional technologies to make an interface of a liquid crystal display device have general versatility, one technology is disclosed in Japanese Patent Application Laid-open No. 2001-142452 (Patent Document 2) in which DCLK signals not occurring within an effective data section shown by DE signals, but within an effective data section shown by HSC signal are counted to judge a resolution of a data signal and the resolution is converted to a level being able to be suitably applied to a liquid crystal display panel being used presently. Another technology is disclosed in Japanese Patent Application Laid-open No. 2001-282191 (Patent Document 3) in which the presence or absence of a DCLK signal within a synchronization section shown by a HSC signal is judged so as to be used for both devices.

However, the above conventional technologies have following problems. Firstly, the conventional device is so configured that, when the VSC and HSC signals are input, even if the DE signal has been input, the synchronization is detected by using the VSC and HSC signals. As a result, a problem arises that, even when the DE signal is input and either of the VSC signal or the HSC signal only is input, the device fails in the detection of occurrence of synchronization.

Secondarily, according to the conventional technology, in order to judge whether or not the VSC, HSC, and DE signals have been input, the DCLK signal in a period during which the VSC signal is high and low is counted up to a predetermined number and, if the period is larger than the predetermined count number, it is judged that the synchronizing signals are not input. However, another problem arises that, in order to judge whether or not the VSC signal has been input, a large-scale counter to count enormous dot clocks for all pixels for one frame is required and, in addition to the counter for the VSC signal, counters for the HSC and the DE signals are necessary, which causes a circuit scale to be larger.

### SUMMARY OF THE INVENTION

In view of the above, it is an object of the present invention to provide a display device and an automatic synchronization judging circuit which are capable of realizing, by using a small-scale circuit, a function of correctly judging a synchronizing signal to serve as a reference signal for displaying operations in any case of combinations of synchronizing signals to be input, including a case in which the synchronizing signals to be input are VSC (vertical sync) and DE (data enable) signals only (an HSC (horizontal synchronizing) signal is not input) or the synchronizing signals to be input are the HSC and DE signals only (the VSC signal is not input).

According to a first aspect of the present invention, there is provided a display device including:

an automatic synchronization judging circuit which judges a vertical synchronizing signal and a horizontal synchronizing signal as a reference signal for displaying operations when a data enable signal has not been input or even if the data enable signal has been input, when a count value of the input data enable signal has not reached a predetermined value, and which judges the data enable signal as the reference signal for the displaying operations when the count value of the input data enable signal has reached the predetermined value, whereby a result of the judgment is output as a judging signal.

In a forgoing first aspect, a preferable mode is one wherein the automatic synchronization judging circuit includes a counter to count the input data enable signal up to the predetermined count being 1 or more and to stop the counting, and a judging circuit to output the judging signal which judges the data enable signal as the reference signal when the counter has counted the input data enable signal up to the predetermined value and which judges the vertical synchronizing signal and the horizontal synchronizing signal as the reference signal for the displaying operations when the counter has not counted the input data enable signal up to the predetermined value.

According to a second aspect of the present invention, there is provided a display device including:

an automatic synchronization judging circuit which judges a vertical synchronizing signal and a horizontal synchronizing signal as a reference signal for displaying operations when a data enable signal has not been input as the synchronizing signal, but when the vertical synchronizing signal and the horizontal synchronizing signal have been input, and which judges the data enable signal as the reference signal for the displaying operations when the data enable signal has been input as the synchronizing signal, even if either of the vertical synchronizing signal or the horizontal synchronizing signal, or both of the vertical synchronizing signal and the horizontal synchronizing signal have been input or have not been input as the synchronizing signal, whereby a result of the judgment is output as a judging signal.

In the foregoing second aspect, a preferable mode is one wherein the automatic synchronization judging circuit outputs a judging signal, based on a result from counting of the input data enable signal, which judges the data enable signal as the reference signal for displaying operations when count value of the input data enable signal has reached a predetermined value being 1 or more, and which judges the vertical synchronizing signal and the horizontal synchronizing signal as the reference signal for the displaying operations when count value of the input data enable signal has not reached a predetermined value.

Also, a preferable mode is one that wherein the automatic synchronization judging circuit includes a counter to count the input data enable signal up to the predetermined count being 1 or more and to stop the counting, and a judging circuit to output the judging signal which judges the data enable signal as the reference signal when the counter has counted the input data enable signal up to the predetermined value and which judges the vertical synchronizing signal and the horizontal synchronizing signal as the reference signal for the displaying operations when the counter has not counted the input data enable signal up to the predetermined value.

According to a third aspect of the present invention, there is provided an automatic synchronization judging circuit so configured as to judge a vertical synchronizing signal and a horizontal synchronizing signal as a reference signal for displaying operations when a data enable signal has not been input or even if the data enable signal has been input, when a count value of the input data enable signal has not reached a predetermined value, and to judge the data enable signal as the reference signal for the displaying operations when the count value of the input data enable signal has reached the predetermined value, whereby a result of the judgment is output as a judging signal.

In the foregoing third aspect, a preferable mode is one that wherein includes a counter to count the input data enable signal up to the predetermined count being 1 or more and to stop the counting, and a judging circuit to output the judging signal which judges the data enable signal as the reference signal when the counter has counted the input data enable signal up to the predetermined value and which judges the vertical synchronizing signal and the horizontal synchronizing signal as the reference signal for the displaying operations when the counter has not counted the input data enable signal up to the predetermined value.

According to a fourth aspect of the present invention, there is provided an automatic synchronization judging circuit so configures as to judge a vertical synchronizing signal and a horizontal synchronizing signal as a reference signal for displaying operations when a data enable signal has not been input as the synchronizing signal, but when the vertical synchronizing signal and the horizontal synchronizing signal have been input, and as to judge the data enable signal as the reference signal for the displaying operations when the data enable signal has been input as the synchronizing signal, even if either of the vertical synchronizing signal or the horizontal synchronizing signal, or both of the vertical synchronizing signal and the horizontal synchronizing signal have been input or have not been input as the synchronizing signal, whereby a result of the judgment is output as a judging signal.

In the foregoing fourth aspect, a preferable mode is one wherein the judging signal is output, based on a result from counting of the data enable signal, which judges the data enable signal as the reference signal for displaying operations when count value of the input data enable signal has reached a predetermined value being 1 or more, and which judges the vertical synchronizing signal and the horizontal synchronizing signal as the reference signal for the displaying operations when count value of the input data enable signal has not reached a predetermined value.

Also, a preferable mode is one that wherein including a counter to count the input data enable signal up to the predetermined count being 1 or more and to stop the counting, and a judging circuit to output the judging signal which judges the data enable signal as the reference signal when the counter has counted the input data enable signal up to the predetermined value and which judges the vertical synchronizing signal and the horizontal synchronizing signal as the reference signal for the displaying operations when the counter has not counted the input data enable signal up to the predetermined value.

With the above configuration, by counting the data enable signal up to the predetermined number being 1 or more to judge the presence or absence of the data enable signal, whether a driving mode is a “fixed mode” using the vertical synchronizing signal and the horizontal synchronizing signal as the reference signal or a “data enable mode” using the data enable signal as the reference signal is judged and, therefore, correct judgement as to whether the driving mode is the “fixed mode” or the “data enable mode” can be made in all cases of combinations of input/non-input of the vertical synchronizing signal, the horizontal synchronizing signal and the data enable signal.

With another configuration as above, by using a counter to count the data enable signals up to the predetermined number being 1 or more to judge the presence or the absence of the data enable signal, whether the driving mode is the “fixed mode” or the “data enable mode” is judged and, therefore, the circuit configuration can be made simpler and can be scaled down more greatly when compared with the conventional technology in which the driving mode is judged by using a plurality of counters including a large-scale counter so configured as to count enormous dot clocks for every one frame.

### BRIEF DESCRIPTION OF THE DRAWINGS

The above and other objects, advantages, and features of the present invention will be more apparent from the following description taken in conjunction with the accompanying drawings in which:

FIG. 1 is a block diagram showing electrical configurations of an automatic synchronization judging circuit employed in a liquid crystal display device according to an embodiment of the present invention;

FIG. 2 is a timing chart showing a first example of operations for judging synchronization in the automatic synchronization judging circuit according to the embodiment of the present invention;

FIG. 3 is a timing chart showing a second example of operations for judging synchronization in the automatic synchronization judging circuit according to the embodiment of the present invention;

FIG. 4 is a timing chart showing a third example of operations for judging synchronization in the automatic synchronization judging circuit according to the embodiment of the present invention;

FIG. 5 is a timing chart showing a fourth example of operations for judging synchronization in the automatic synchronization judging circuit according to the embodiment of the present invention;

FIG. 6 is a timing chart showing a fifth example of operations for judging synchronization in the automatic synchronization judging circuit according to the embodiment of the present invention;

FIG. 7 is a timing chart showing a sixth example of operations for judging synchronization in the automatic synchronization judging circuit according to the embodiment of the present invention;

FIG. 8 is a timing chart for showing a seventh example of operations for judging synchronization in the automatic synchronization judging circuit according to the embodiment of the present invention; and

FIG. 9 is a block diagram showing an example of electrical configurations of a conventional liquid crystal display device.

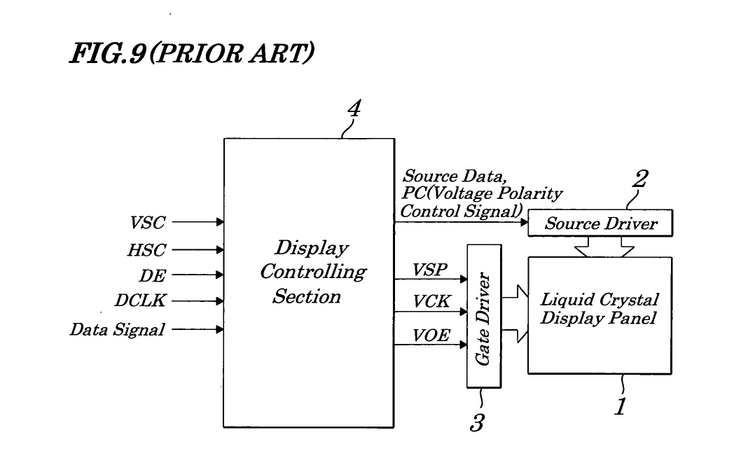

### DETAILED DESCRIPTION OF THE PREFERRED EMBODIMENTS

Best modes of carrying out the present invention will be described in further detail using various embodiments with reference to the accompanying drawings. According to best modes of the present invention, by counting a DE (data enable) signal up to a predetermined number being 1 or more to judge the presence or absence of the DE signal, a display device to be used in a liquid crystal display device and an automatic synchronization judging circuit to be used in the display device can be achieved which are able to realize, by a small-scale circuit, a function of correctly judging a synchronizing signal to serve as a reference signal for displaying operations in any case of combinations of synchronizing signals to be input. The best modes of present invention are characterized in that the function of automatically and correctly judging which input synchronization signal out of VSC (vertical synchronizing) and HSC (horizontal synchronizing) signals and the DE signal is to be used as the reference signal for making the liquid crystal display device display data can be realized by the simple and small-sized circuit. In this specification, a driving method of making the liquid crystal device display data by using the VSC signal and the HSC signal as the reference signal is called a “fixed mode” and a method of making the liquid crystal device display data by using the DE signal as the reference signal is called a “DE mode (Data Enable mode)”.

### EMBODIMENT

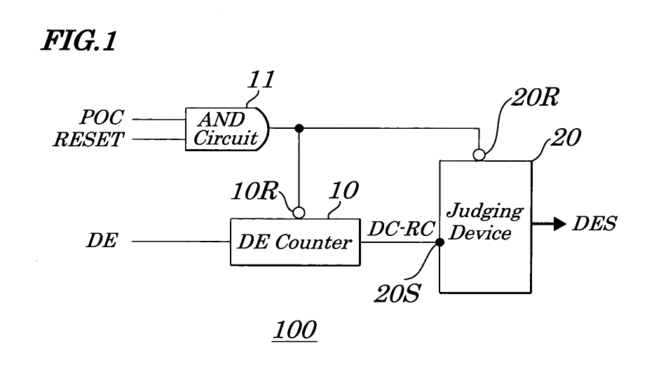

FIG. 1 is a block diagram showing electrical configurations of an automatic synchronization judging circuit 100 to be employed in a liquid crystal display device according to an embodiment of the present invention. The automatic synchronization judging circuit 100 includes a DE counter 10, an AND circuit 11, and a judging device 20. The DE counter 10 counts a data enable (DE) signal. The judging device 20 generates a judging signal DES by using a count value of the DE counter 10. Whether the driving method is a “fixed mode” or a “DE mode” is judged based on the judging signal DES. The AND circuit 11 outputs a reset signal to be used for the DE counter 10 and the judging device 20.

To a reset terminal 10R of the DE counter 10 is input a reset signal output from the AND circuit 11 and to its count inputting terminal is input a DE signal as a count signal. The DE counter 10 is reset by the rising edge of a reset signal output from the AND circuit 11.

To an input port of the AND circuit 11 is input a POC signal and a RESET signal. The DE counter 10 is reset by the rising edge of the POC signal or the RESET signal. The POC signal is a reset signal which is input only once when power is applied. The RESET signal is a reset signal to be input arbitrarily. The DE counter 10 starts to count up DE signals when the DE signals are input and stops the counting-up when the DE counter has counted up to a number “n”. The DE counter generates a DC-RC signal which goes high when the count value of the DE counter 10 becomes “n”. Here, the “n” is an integer of 1 or more.

The judging device 20 is made up of a flip-flop or a like. To a reset terminal 20R of the judging device 20 is input an output from the above AND circuit 11 as a reset signal and to its set terminal 20S is input a DC-RC signal fed from the DE counter 10. The judging device 20 then generates a DES signal. This causes the DES signal generated by the judging device 20 to be set to be high on the rising of the POC signal and to be set to be low on the rising of the DC-RC signal. According to this DES signal, whether the driving method is the “fixed mode” or the “DE mode” is automatically judged. That is, if the DES signal is high, the driving method is judged as the “fixed mode” and if low, the driving method as the “DE mode”. When the driving mode is judged as the “fixed mode”, a display controlling section (not shown) drives a liquid crystal display panel (not shown) so that data are displayed according to a VSC (vertical synchronizing) signal and an HSC horizontal synchronizing) signal used as a reference signal and, when the driving mode is judged as the “DE mode”, so that data are displayed according to the DE signal used as the reference signal.

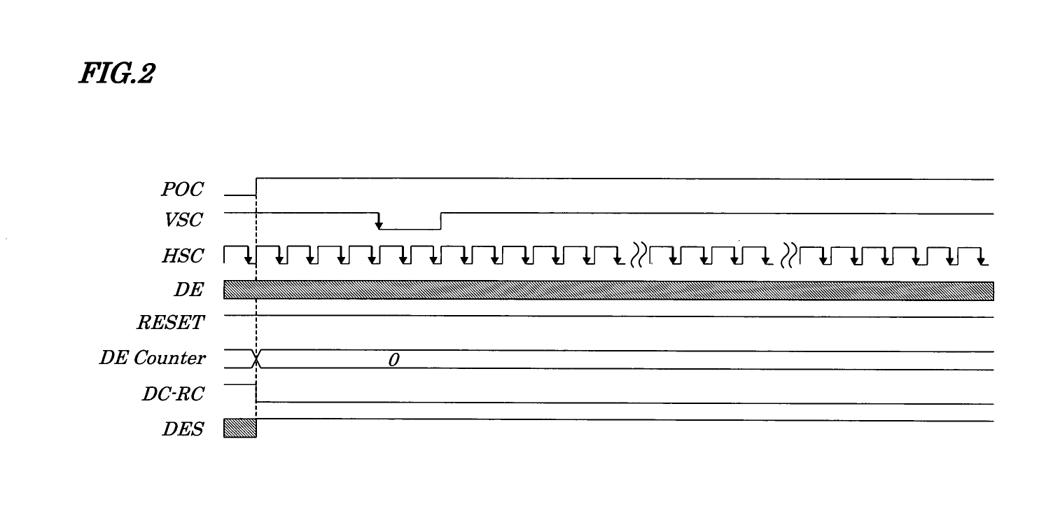

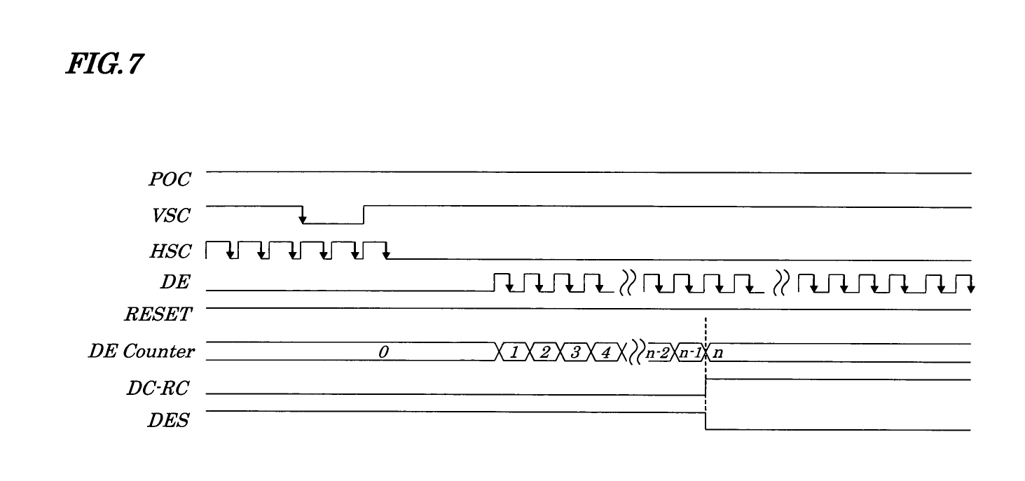

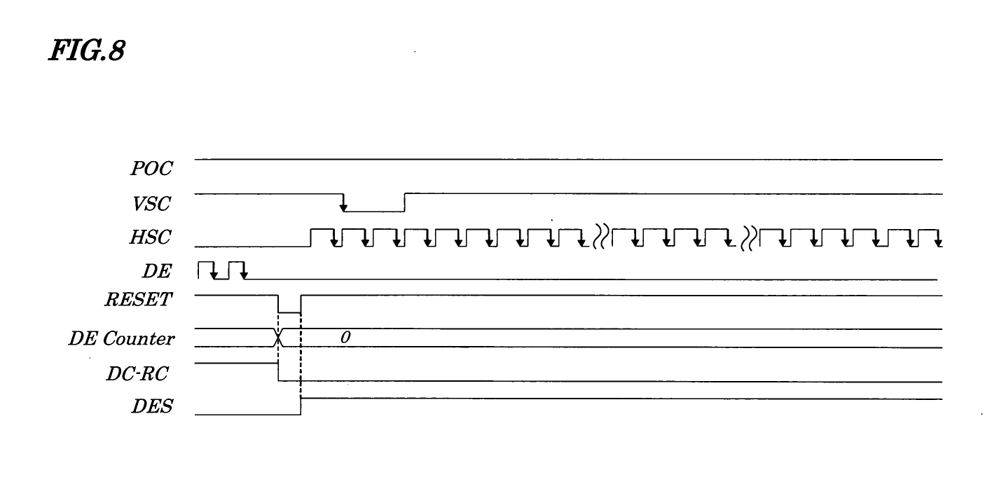

Next, an example of operations for judging synchronization of the embodiment is explained. FIGS. 2 to 8 are timing charts showing examples of operations for judging synchronization in the embodiment of the present invention. FIGS. 2 to 6 show examples (first to fifth examples) of operations for judging synchronization to be performed when a combination of input/non-input of a synchronizing signal is determined from time of applying power. FIGS. 7 to 8 show examples (sixth to seventh example) of operations for judging synchronization to be performed when a combination of input/non-input of a synchronizing signal is changed in the middle course of the operations.

Operations (first example) to be performed when the VSC signal and the HSC signal have been input and a DE signal has not been input (logically indeterminate state) are described by referring to the timing chart of FIG. 2. When power is provided, the DE counter 10 is reset by a POC signal and the DES signal is set to be high. Since the DE signal has not been input, the DE counter 10 does not count up the DE signal and its count value remains at “0” (zero) . As a result, a DC-RC signal is made to remain low. Since the DC-RC signal remains low and the judging signal DES being an output from the judging device 20 also remains low, without any change, the judging device 20 judges that the driving method is the “fixed mode”.

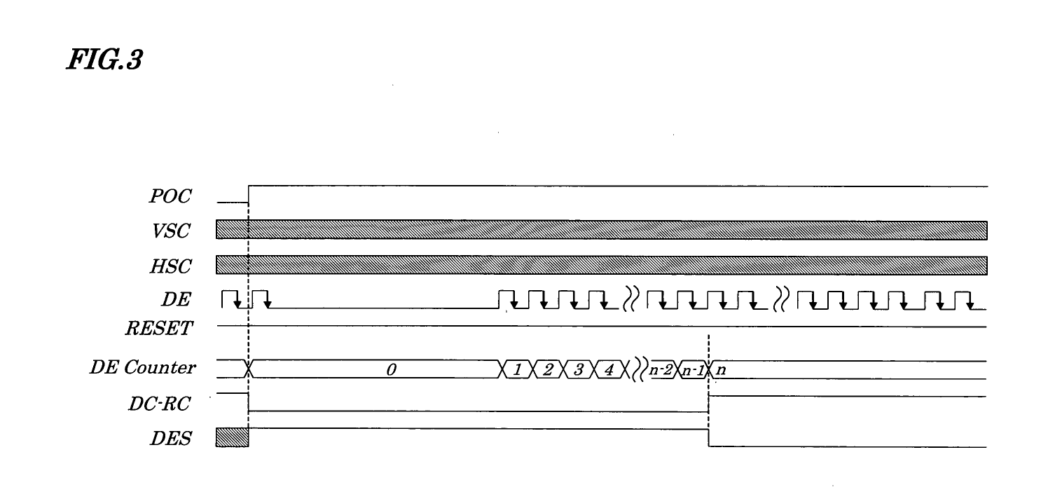

Next, operations (second example) to be performed when the VSC signal and the HSC signal have not been input (logically indeterminate state) and a DE signal has been input are described by referring to the timing chart of FIG. 3. When power is provided, the DE counter 10 is reset by a POC signal and the DES signal is set to be high. Since the DE signal is being input, the DE counter 10 starts to count up the DE signal and generates a DC-RC signal which goes high when the count value of the DE counter 10 becomes “n” and then stops the counting-up. The judging device 20 sets the DES signal to be low on the rising edge of the DC-RC signal and judges that the driving method is the “DE mode”.

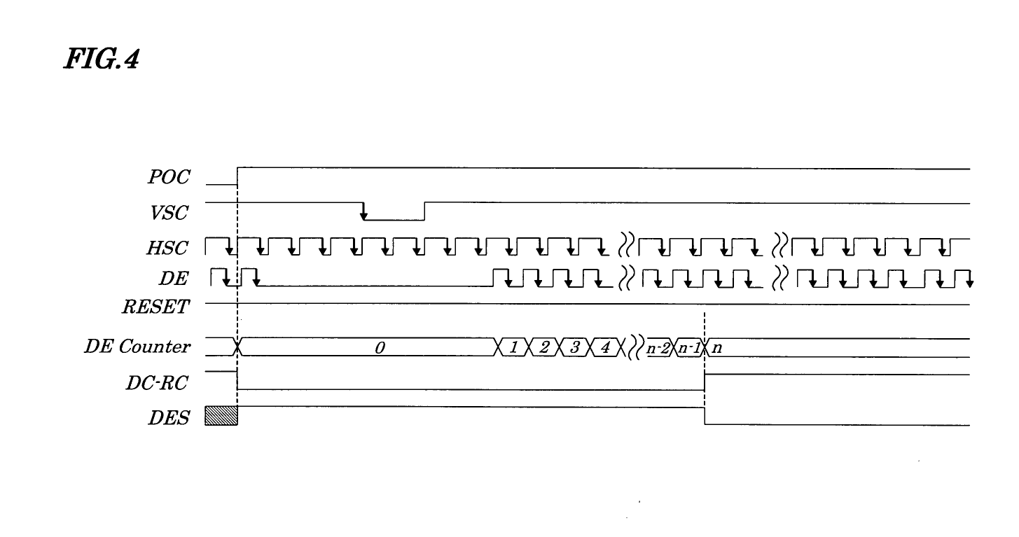

Next, operations (third example) to be performed when VSC and HSC signals have been input, and a DE signal is input are described by referring to the timing chart of FIG. 4. When power is provided, the DE counter 10 is reset by a POC signal and the DES signal is set to be high. Since the DE signal is input, the DE counter 10 starts to count up the DE signal and generates a DC-RC signal which goes high when the count value of the DE counter 10 becomes “n” and then stops the counting-up. The judging device 20 sets the DES signal to be low on the rising edge of the DC-RC signal and judges that the driving method is the “DE mode”.

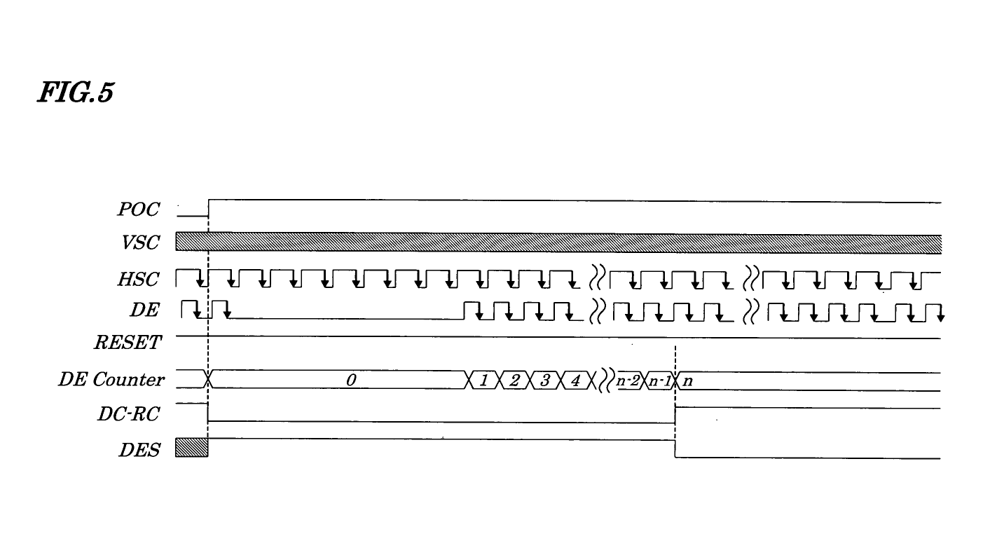

Next, operations (fourth example) to be performed when a VSC signal has not been input (logically indeterminate state) and a HSC signal has been input and a DE signal is input are described by referring to the timing chart of FIG. 5. When power is provided, the DE counter 10 is reset by a POC signal and the DES signal is set to be high. Since the DE signal is input, the DE counter 10 starts to count up the DE signal and generates a DC-RC signal which goes high when the count value of the DE counter 10 becomes “n” and then stops the counting-up. The judging device 20 sets the DES signal to be low on the rising edge of the DC-RC signal and judges that the driving method is the “DE mode”.

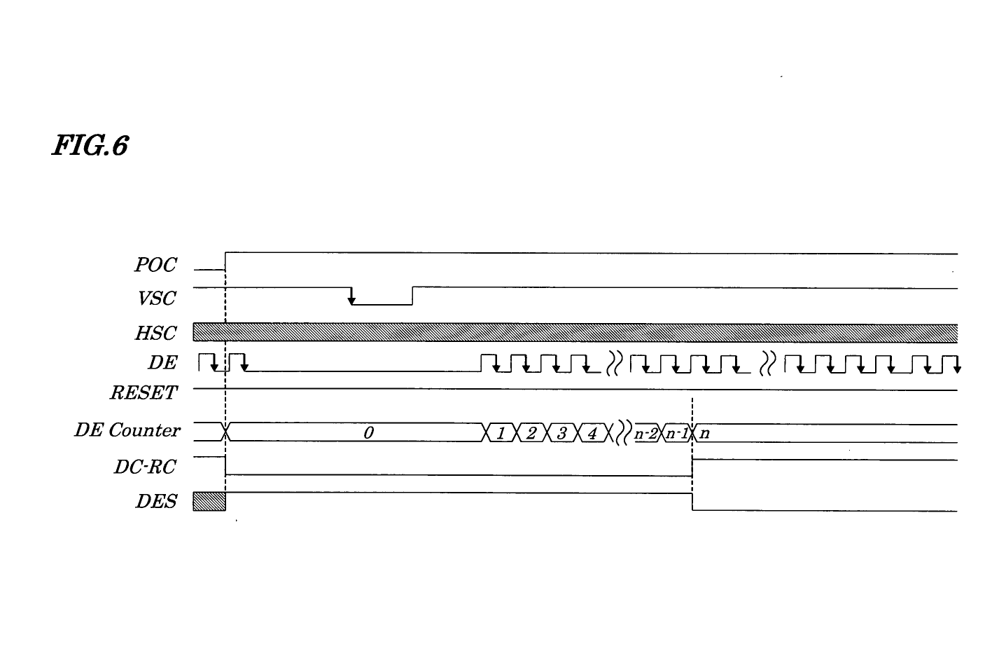

Next, operations (fifth example) to be performed when the VSC signal and the HSC signal has not been input (logically indeterminate state) and a DE signal is input are described by referring to the timing chart of FIG. 6. When power is provided, the DE counter 10 is reset by a POC signal and the DES signal is set to be high. Since the DE signal is input, the DE counter 10 starts to count up the DE signal and generates a DC-RC signal which goes high when the count value of the DE counter 10 becomes “n” and then stops the counting-up. The judging device 20 sets the DES signal to be low on the rising edge of the DC-RC signal and judges that the driving method is the “DE mode”.

Next, operations (sixth example) to be performed when the inputting state of a synchronizing signal is changed from a state where the VSC signal and the HSC signal have been input and a DE signal has not been input to a state where the VSC signal and the HSV signal have not been input and the DE signal is input are described by referring to FIG. 7. As explained by referring to FIG. 2, in the case where the VSC signal and the HSC signal have been input and the DE signal has not been input, the driving method has been already judged as the “fixed mode”. When the inputting state of the synchronizing signal is changed from this state to a state where the VSC signal and the HSC signal have not been input and the DE signal is input, since the DE signal is input, the DE counter 10 starts to count up the DE signal and generates a DC-RC signal which goes high when the count value of the DE counter 10 becomes “n” and then stops the counting-up. The judging device 20 sets the DES signal to be low on the rising edge of the DC-RC signal and judges that the driving method is the “DE mode”.

Finally, operations (seventh example) to be performed when the inputting state of a synchronizing signal is changed from a state where the VSC signal and the HSC signal have not been input and a DE signal is input to a state where the VSC and HSC signals have been input and the DE signal has not been input are described by referring to the timing chart in FIG. 8. As explained by referring to FIG. 3, in the case where the VSC signal and the HSC signal have not been input and the DE signal is input, the driving method has been already judged as the “DE mode”. When the inputting state of the synchronizing signal is changed from this state to a state where the VSC signal and the HSC signal have been input and the DE signal has not been input, the DE counter 10 and the judging device 20 are initialized by a RESET signal. Since the DE signal is not being input, the DE counter 10 does not perform the counting-up and its count value remains at “0” (zero). As a result, a DC-RC signal is made to remain low. Since the DC-RC signal remains low and the judging signal DES being an output from the judging device 20 also remains high without any change, the driving method is judged as the “fixed mode”.

Moreover, though it is estimated that such an example of changing a synchronization mode is small, other examples include a case where a display mode is switched by external circuits such as a plurality of personal computers each operating in a different synchronization mode being connected to one liquid crystal display device. In this case, a RESET signal can be easily generated by a display switching means at time of the switching and, therefore, the generated RESET signal may be input from the outside together with a synchronizing signal to be changed.

Thus, in all combinations of input/non-input of the VSC signal, the HSC signal, and the DE signal, it is possible to correctly judge whether the driving method is the “fixed mode” or the “DE mode”. Judgement on whether the driving method is the “fixed mode” or the “DE mode” is made by using one counter that can count a DE signal up to a predetermined number being 1 or more and, therefore, it is possible to make simpler the circuit configuration and to more greatly scale down the circuit when compared with the conventional technology in which the mode judgement is made by using a plurality of counters including a large-scale counter so configured as to count enormous dot clocks for every one frame.

It is apparent that the present invention is not limited to the above embodiments but may be changed and modified without departing from the scope and spirit of the invention. For example, in the above embodiment, the case is explained in which the present invention is applied to liquid crystal display devices, however, the present invention can be widely applied to display devices such as CRT (Cathode Ray Tube) display devices, organic EL (Electroluminescent) display devices, plasma display devices, or a like. Moreover, FIG. 8 explains synchronization judging operations to be applied to the case in which the driving mode is changed from the “DE mode” described in FIG. 3 to the “fixed mode”, however, the same synchronization judging operations as applied in FIG. 8 may be applied also to a case in which the driving mode is changed from the “DE mode” described in FIGS. 4 to 6 to the “fixed mode”.

What is claimed is:

1. A display device comprising:
an automatic synchronization judging circuit which judges a vertical synchronizing signal and a horizontal synchronizing signal as a reference signal for displaying operations when a data enable signal has not been input or even if the data enable signal has been input, when a count value of the input data enable signal has not reached a predetermined value, and which judges the data enable signal as the reference signal for the displaying operations when the count value of the input data enable signal has reached the predetermined value, whereby a result of the judgment is output as a judging signal.

2. The display device according to claim 1, wherein said automatic synchronization judging circuit comprises a counter to count the input data enable signal up to the predetermined count being 1 or more and to stop the counting, and a judging circuit to output the judging signal which judges the data enable signal as the reference signal when said counter has counted the input data enable signal up to the predetermined value and which judges the vertical synchronizing signal and the horizontal synchronizing signal as the reference signal for the displaying operations when said counter has not counted the input data enable signal up to said predetermined value.

3. A display device comprising:
an automatic synchronization judging circuit which judges a vertical synchronizing signal and a horizontal synchronizing signal as a reference signal for displaying operations when a data enable signal has not been input as the synchronizing signal, but when the vertical synchronizing signal and the horizontal synchronizing signal have been input, and which judges the data enable signal as the reference signal for the displaying operations when the data enable signal has been input as the synchronizing signal, even if either of the vertical synchronizing signal or the horizontal synchronizing signal, or both of the vertical synchronizing signal and the horizontal synchronizing signal have been input or have not been input as the synchronizing signal, whereby a result of the judgment is output as a judging signal.

4. The display device according to claim 3, wherein said automatic synchronization judging circuit outputs a judging signal, based on a result from counting of the input data enable signal, which judges the data enable signal as the reference signal for displaying operations when count value of the input data enable signal has reached a predetermined value being 1 or more, and which judges the vertical synchronizing signal and the horizontal synchronizing signal as the reference signal for the displaying operations when count value of the input data enable signal has not reached a predetermined value.

5. The display device according to claim 4, wherein said automatic synchronization judging circuit comprises a counter to count the input data enable signal up to the predetermined count being 1 or more and to stop the counting, and a judging circuit to output the judging signal which judges the data enable signal as the reference signal when said counter has counted the input data enable signal up to the predetermined value and which judges the vertical synchronizing signal and the horizontal synchronizing signal as the reference signal for the displaying operations when said counter has not counted the input data enable signal up to said predetermined value.

6. An automatic synchronization judging circuit so configured as to judge a vertical synchronizing signal and a horizontal synchronizing signal as a reference signal for displaying operations when a data enable signal has not been input or even if the data enable signal has been input, when a count value of the input data enable signal has not reached a predetermined value, and to judge the data enable signal as the reference signal for the displaying operations when the count value of the input data enable signal has reached the predetermined value, whereby a result of the judgment is output as a judging signal.

7. The automatic synchronization judging circuit according to claim 6, comprises a counter to count the input data enable signal up to the predetermined count being 1 or more and to stop the counting, and a judging circuit to output the judging signal which judges the data enable signal as the reference signal when said counter has counted the input data enable signal up to the predetermined value and which judges the vertical synchronizing signal and the horizontal synchronizing signal as the reference signal for the displaying operations when said counter has not counted the input data enable signal up to said predetermined value.

8. An automatic synchronization judging circuit so configures as to judge a vertical synchronizing signal and a horizontal synchronizing signal as a reference signal for displaying operations when a data enable signal has not been input as the synchronizing signal, but when the vertical synchronizing signal and the horizontal synchronizing signal have been input, and as to judge the data enable signal as the reference signal for the displaying operations when the data enable signal has been input as the synchronizing signal, even if either of the vertical synchronizing signal or the horizontal synchronizing signal, or both of the vertical synchronizing signal and the horizontal synchronizing signal have been input or have not been input as the synchronizing signal, whereby a result of the judgment is output as a judging signal.

9. The automatic synchronization judging circuit according to claim 8, wherein the judging signal is output, based on a result from counting of the data enable signal, which judges the data enable signal as the reference signal for displaying operations when count value of the input data enable signal has reached a predetermined value being 1 or more, and which judges the vertical synchronizing signal and the horizontal synchronizing signal as the reference signal for the displaying operations when count value of the input data enable signal has not reached a predetermined value.

10. The automatic synchronization judging circuit according to claim 9, comprising a counter to count the input data enable signal up to the predetermined count being 1 or more and to stop the counting, and a judging circuit to output the judging signal which judges the data enable signal as the reference signal when said counter has counted the input data enable signal up to the predetermined value and which judges the vertical synchronizing signal and the horizontal synchronizing signal as the reference signal for the displaying operations when said counter has not counted the input data enable signal up to said predetermined value.

11. A display device comprising:
an automatic synchronization judging means which judges a vertical synchronizing signal and a horizontal synchronizing signal as a reference signal for displaying operations when a data enable signal has not been input or even if the data enable signal has been input, when a count value of the input data enable signal has not reached a predetermined value, and which judges the data enable signal as the reference signal for the displaying operations when the count value of the input data enable signal has reached the predetermined value, whereby a result of the judgment is output as a judging signal.

12. The display device according to claim 11, wherein said automatic synchronization judging means comprises a counting means to count the input data enable signal up to the predetermined count being 1 or more and to stop the counting, and a judging means to output the judging signal which judges the data enable signal as the reference signal when said counting means has counted the input data enable signal up to the predetermined value and which judges the vertical synchronizing signal and the horizontal synchronizing signal as the reference signal for the displaying operations when said counting means has not counted the input data enable signal up to said predetermined value.

13. A display device comprising:
an automatic synchronization judging means which judges a vertical synchronizing signal and a horizontal synchronizing signal as a reference signal for displaying operations when a data enable signal has not been input as the synchronizing signal, but when the vertical synchronizing signal and the horizontal synchronizing signal have been input, and which judges the data enable signal as the reference signal for the displaying operations when the data enable signal has been input as the synchronizing signal, even if either of the vertical synchronizing signal or the horizontal synchronizing signal, or both of the vertical synchronizing signal and the horizontal synchronizing signal have been input or have not been input as the synchronizing signal, whereby a result of the judgment is output as a judging signal.

14. The display device according to claim 13, wherein said automatic synchronization judging means outputs a judging signal, based on a result from counting of the input data enable signal, which judges the data enable signal as the reference signal for displaying operations when count value of the input data enable signal has reached a predetermined value being 1 or more, and which judges the vertical synchronizing signal and the horizontal synchronizing signal as the reference signal for the displaying operations when count value of the input data enable signal has not reached a predetermined value.

15. The display device according to claim 14, wherein said automatic synchronization judging means comprises a counting means to count the input data enable signal up to the predetermined count being 1 or more and to stop the counting, and a judging means to output the judging signal which judges the data enable signal as the reference signal when said counting means has counted the input data enable signal up to the predetermined value and which judges the vertical synchronizing signal and the horizontal synchronizing signal as the reference signal for the displaying operations when said counting means has not counted the input data enable signal up to said predetermined value.
